(19) United States
(12) Patent Application Publication
(10) Pub. No.: US 2023/0061766 A1
(43) Pub. Date: Mar. 2, 2023

(54) 3D CONCRETE PRINTING WITH WELL ANCHORING CORDS

(71) Applicant: NV Bekaert SA, Zwevegem (BE)

(72) Inventors: Matthias GOUWY, Sint-Jans-Molenbeek (BE); Jan MESTDAGH, Oostrozebeke (BE)

(73) Assignee: NV Bekaert SA, Zwevegem (BE)

(21) Appl. No.: 17/796,942

(22) PCT Filed: Feb. 16, 2021
(86) PCT No.: PCT/EP2021/053759

§ 371 Date: Aug. 2, 2022

(30) Foreign Application Priority Data
Mar. 4, 2020 (EP) 20160825.4

(51) Int. Cl. B28B 1/00; B28B 23/22; C04B 41/45

(52) U.S. Cl. CPC B28B 1/001; B28B 23/22; C04B 41/4586; C04B 2111/00129

(57) ABSTRACT

A concrete construction (100) made by 3D concrete printing that contains: two or more layers (102, 106) of cementitious material extruded one above the other, and at least one elongated steel element (104, 108) reinforcing at least one of the two or more layers. The elongated steel element (104, 108) is provided with a first crimp. Due to the crimp, a good anchorage in concrete is obtained and the anchorage force is predictable, since the standard deviation of the anchorage force is very small. The elongated steel element can be a single steel wire with a diameter D, the amplitude of the crimp ranges from 1.05×D to 5.0×D. The elongated steel element can also be a steel with steel filaments having a maximum diameter d. The amplitude of the crimp ranges from 1.05×d to 5.0×d.

### TECHNICAL FIELD

The invention relates to a concrete construction that has been made by 3D concrete printing.

### BACKGROUND ART

Additive manufacturing of concrete or cementitious materials, herein referred to as ‘3D concrete printing’, has been expanding rapidly over the past years. According to the technique of 3D concrete printing, a pump feeds a cementitious slurry via a hose to a printing nozzle that extrudes the slurry layer by layer. A gantry robot guides and moves the whole, i.e. the hose and the printing nozzle.

Structures of a cementitious matrix in general, and concrete structures in particular, are known to be brittle and to have a poor resistance to tensile or bending stresses. Adding reinforcement to these structures has given these structures more ductility.

The brittle nature is also a problem for structures made by 3D concrete printing.

Traditional reinforcement such as a rebar can be inserted in the printed layers of concrete while the concrete is still uncured. This solution, however, has serious drawbacks. It is labour intensive, error-prone and the adhesion between the rebar and the concrete will be inadequate. In addition, this solution is against the final goal of 3D concrete printing, namely to minimize manual work.

Reinforcement fibres may be added to the cementitious slurry. But experience has shown that a mix of cementitious slurry and concrete is difficult to feed through the hose and printing nozzle.

Another way of solving the problem of reinforcement, is to install a reinforcement lattice or net in advance and to extrude the cementitious slurry around it. Here again, the advance installation of the reinforcement demands labour that one wishes to avoid. Moreover, the presence of the reinforcement complicates the extrusion and the working of the printing head.

The Technical University of Eindhoven in cooperation with Bekaert has come up with an elegant solution that allows depositing simultaneously both the concrete and the reinforcement. A reinforcement entraining device having a spool with a flexible steel cord was added to the printer head. This entraining device travels together with the gantry robot, unwinds the flexible steel cord from the spool and introduces this flexible steel cord inside the deposited concrete layer. In this way simultaneous deposition of both concrete and reinforcement was obtained.

While the used steel cords have a lot of advantages such as light weight, high tensile strength and flexibility, their reinforcement effect was not adequate and predictable to qualify for reinforcement of load bearing structures.

### DISCLOSURE OF INVENTION

It is a general object of the invention to mitigate the drawbacks of the prior art.

It is a more particular object of the invention provide for a reinforcement for 3D concrete printed constructions that is more predictable.

It is a further object of the invention to provide for a reinforcement for 3D concrete printed constructions that is more adequate.

According to the invention, there is provided a concrete construction made by 3D concrete printing. The construction comprises two or more layers of cementitious material extruded one above the other. The construction further comprises at least one elongated steel element being positioned inside the two or more layers and reinforcing the two or more layers. The elongated steel element may be a steel wire or a steel cord. The steel cord may be a single strand steel cord and comprises twisted steel filaments or may be a multi-strand steel cord that comprises twisted steel strands where each of the strands has twisted steel filaments.

The first crimp has a first amplitude along following lines:
in case of a single steel wire with diameter D, the first amplitude ranges from 1.05×D to 5×D;
in case of a single strand steel cord where the filaments have a maximum diameter d, the first amplitude ranges from 1.05×d to 5.0×d;
in case of a multi-strand steel cord where the steel strands have a maximum diameter d′, the first amplitude ranges from 1.05×d′ to 5.0×d′. Below 1.05 times the relevant diameter (D, d or d′), the effect of improved anchorage in concrete and decreased standard deviation is less pronounced. Above 5 times the relevant diameter (D, d or d′), handling of the elongated steel element becomes more difficult and, in case of a steel cord, its construction becomes less stable.

The steel wire or the steel cord may be provided with a second crimp different from the first crimp. The second crimp has a second amplitude that lies in the same ranges as the first crimp.

The terms ‘cementitious material’ refer to concrete, mortar, cement, or similar material.

The term ‘crimp’ refers to a plastic deformation in the form of an undulation of the steel filament or steel strand. This undulation results in lateral protrusions of the steel filament or steel strand. These protrusions along the length of the steel cord result in an improved anchorage of the steel cord in the concrete once cured. In addition, the degree of anchorage of the steel cord in the concrete shows less deviations from what is expected, so the anchorage behaviour is more predictable. Hence, over-design or too high security factors can be avoided.

In case of a multi-strand steel cord comprising three or more steel strands, some of these steel strands are exposed to the radially external side of the steel cord and are referred to as external layer strands. Some of these external layer strands and preferably all of these external layer strands are provided with a first crimp.

In case of a single strand steel cord having various steel filaments twisted with each other, some of these steel filaments are exposed to the radially external side of the steel cord and are referred to as external layer filaments. Some of these external layer filaments and preferably all of these external layer filaments are provided with a first crimp.

As mentioned, in a highly preferable embodiment of the invention, a second crimp may be provided to the steel filaments or the steel strands.

Typical features of a crimp are its amplitude and its pitch.

Typical dimensions of the pitch range from 5 times the relevant diameter (wire diameter D, filament diameter d or strand diameter d′) to 50 times the relevant diameter of the elongated steel element. Preferably, in case of a steel cord, the pitch of the crimp is smaller than the prevailing lay length of the steel cord. The terms ‘prevailing lay length’ of a steel cord are to be understood as the lay length of the radially external filaments in case of a single strand steel cord or the lay length of the radially external strands in case of a multi-strand steel cord.

Preferably, the first crimp has a first amplitude that is different from the second amplitude of the second crimp.

Preferably, the first crimp has a first pitch that is different from the second pitch of the second crimp.

A way of giving a crimp to a steel wire or a steel filament or steel strand is driving the elongated steel element between a pair of toothed wheels. This pair of toothed wheels may lie in one plane and this plane can be called the plane of the crimp.

The first crimp may have a first plane and the second crimp may have a second crimp. Preferably, the first plane of the first crimp is different from the second plane of the second crimp.

The elongated steel element may be provided with a corrosion resistant coating. This coating may be metallic or polymeric. In case of zinc or a zinc alloy layer as metallic coating, the elongated element is preferably treated with benzimidazole.

According to an alternative aspect of the invention, there is provided a process of manufacturing a concrete construction as mentioned hereabove. The elongated steel element is fed simultaneously together with the cementitious material through a same printer head or nozzle.

### BRIEF DESCRIPTION OF FIGURES IN THE DRAWINGS

FIG. 1 illustrates how a continuous reinforcement is added in 3D concrete printing;

FIG. 2, FIG. 3 and FIG. 4 show cross-sections of steel cords;

FIG. 5 illustrates how a double crimp is given to a steel filament;

FIG. 6 illustrates amplitude and pitch of a first crimp;

FIG. 7 illustrates amplitude and pitch of a second crimp.

### MODE(S) FOR CARRYING OUT THE INVENTION

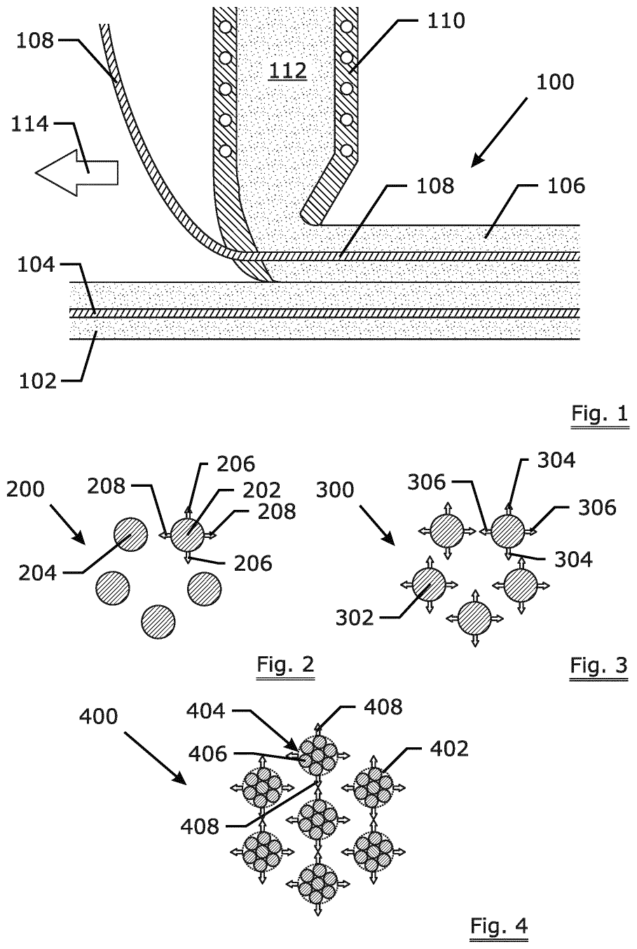

FIG. 1 illustrates how a construction 100 with reinforcement is made by 3D concrete printing. The construction 100 has a first layer 102 that is reinforced by a steel cord 104. The construction 100 also has a second layer 106 that is reinforced by a steel cord 108, that may be the same steel cord as the steel cord 104 of the first layer. The second layer 106 is in the process of being extruded above the first layer 102. This extrusion is done by means of a printer head or nozzle 110 that is feeding the concrete 112 and the steel cord 108 simultaneously. The printer head 110 is moving in the direction of the arrow 114.

FIG. 2 shows a cross-section of a single strand steel cord 200 that is suitable to be used in the present invention. The steel cord 200 has five individual steel filaments 202, 204. One steel filament 202 has two crimps, each crimp lying in another plane. This is symbolically shown by the arrows 206, 208. The other filaments 204 are not provided with crimps.

FIG. 3 shows a cross-section of another single strand steel cord 300 that is suitable to be used in the present invention. The steel cord 300 has five filaments 302. All steel filaments 302 have two crimps, each crimp lying in another plane. This is symbolically shown by the arrows 304, 306. An example of such a steel cord is 5×0.35 (steel filament diameter 0.35 mm) or 5×0.38 (steel filament diameter 0.38 mm).

FIG. 4 shows a cross-section of a multi-strand steel cord 400. The steel cord 400 has several steel strands 402, 404. Each of the steel strands 402, 404 comprises several steel filaments 406 that are twisted with each other. At least one steel strand 404 has been provided with a crimp, here represented by arrows 408.

In general the steel filaments may have a filament diameter d ranging from 0.03 mm to 0.65 mm, e.g. from 0.10 mm to 0.40 mm.

In case of a single steel wire, the wire diameter D ranges from 0.20 mm to 2.0 mm, e.g. from 0.35 mm to 1.50 mm.

In case of a steel strand in a multi-strand steel cord, the diameter d′ of the steel strand may range from 0.25 mm to 0.75 mm, e.g. from 0.30 mm to 0.75 mm.

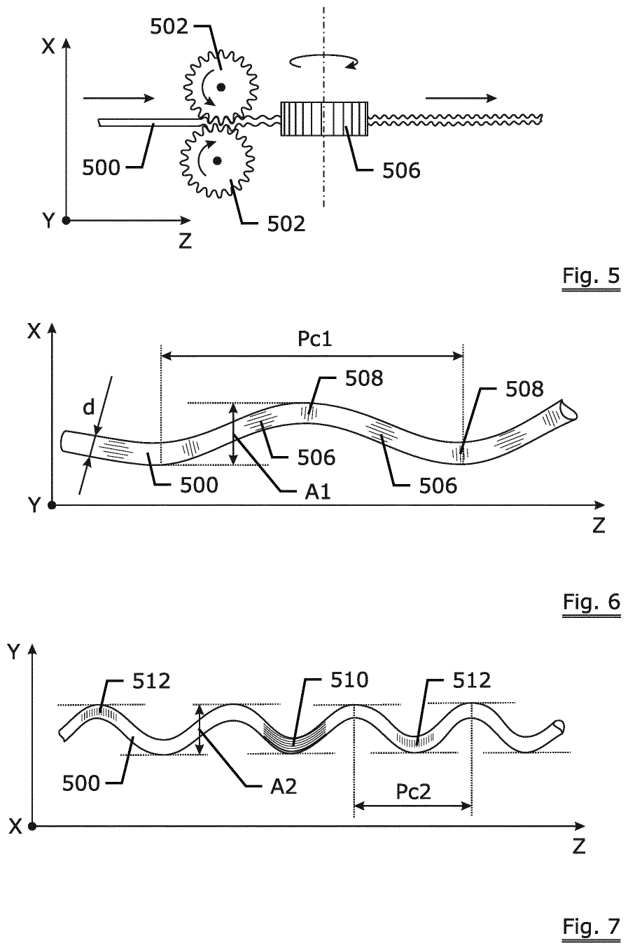

FIG. 5 schematically illustrates how a first crimp and a second crimp are provided to a steel filament 500.

The steel filament 500 is moved downstream towards a first pair of toothed wheels 502. The axes of rotation of toothed wheels 502 lie parallel to the y-axis, and the first crimp given is a planar crimp lying in plane xz.

The thus crimped filament 500 is further moved to a second pair of toothed wheels 506. The axes of rotation of toothed wheels 506 lie parallel with the x-axis. The second crimp given by toothed wheels 506 is also a planar crimp and lies in plane yz.

Obviously the resulting wave given to the steel filament 10 is no longer planar but spatial.

Neither the first pair of toothed wheels 502 nor the second pair of toothed wheels 506 need to be driven by external means. They are both driven and rotated by the passing steel filament 500.

It is important that the second pair of toothed wheels 506 is positioned as close as possible to the first pair of toothed wheels 502 in order to prevent the first crimp from tilting or rotating from plane xz to plane yz under influence of the second crimp.

From a more general point of view and in order to control the two crimps given to the filaments, the bending moment, i.e. the moment necessary to give the two crimps, must be kept as small as possible. This can be done, e.g. by applying first the crimp with the smaller amplitude and only thereafter the crimp with the greater amplitude.

Still from a more general point of view, the torsion moment, i.e. the moment necessary to rotate the filament, should be kept as high as possible, since the rotating of the filament must be prevented during or between the two crimping operations. One way to keep the torsion moment as high as possible is the above-mentioned minimum distance between the two pairs of crimping wheels.

A third and following pairs of toothed wheels may be provided in other planes or in the same planes. In this way the spatial structure obtained by the subsequent crimping operations may be optimised or varied to a further degree.

FIG. 6 shows the first crimp lying in plane xz and FIG. 7 shows the second crimp lying in plane yz.

The first crimp has a first crimp amplitude A1, which is measured from top to top, with inclusion of filament diameter d. The first crimp has a first crimp pitch Pc1, which is equal to the distance between two minima of the first crimp.

The second crimp has a second crimp amplitude A2, which is measured from top to top, with inclusion of filament diameter d. The second crimp has a second crimp pitch Pc2, which is equal to the distance between two minima of the second crimp.

The spots 506 where the second crimp reaches its maxima are hatched in parallel with the axis of the steel filament 500, and the spots 508 where the second crimp reaches its minima are hatched vertically in FIG. 6.

The spots 510 where the first crimp reaches its maxima are hatched in parallel with the axis of the steel filament 500, and the spots 512 where the first crimp reaches its minima are hatched vertically in FIG. 7.

Both the first crimp amplitude A1 and the second crimp amplitude A2 may be varied independently of each other. So A1 may be equal to A2 or may be different from A2. Both amplitudes may vary between a minimum value which is slightly above value of the filament diameter (e.g. 1.05×d, which means almost no crimp), and a maximum value of about four to five times the filament diameter (4˜5×d). This maximum value is dictated for reason of constructional stability.

Both the first crimp pitch Pc1 and the second crimp pitch Pc2 may be varied independently of each other. So Pc1 may be equal to Pc2 or may be different from Pc2. The more Pc1 differs from Pc2, the more easy it is to prevent the first crimp from tilting. Both pitches may vary between a minimum value which is about five times the filament diameter d (5×d), and a maximum value of about fifty times the filament diameter d (50×d). It is, however, to be preferred, that in twisted structures at least one, and most preferably both, of the crimp pitches is smaller than the twist pitch of the steel filament in the twisted structure.

Having regard to the above parameters which may be chosen quite freely, i.e. independent of each other, a large variety of wave forms can be obtained.

A first example is that by choosing A1 equal to A2 and Pc1 equal to Pc2 and by shifting the second crimp with a quarter of a pitch in respect of the first crimp, a spatial helix form can be obtained or at least be approximated without the need for driven rotatory preforming pins.

A second example is that by choosing A1 substantially greater than A2 an oval or elliptical transversal cross-section is obtained.

Steel Composition

The steel filaments may have a steel composition along following lines: A plain carbon composition is along following lines (all percentages being percentages by weight):
a carbon content (% C) ranging from 0.60% to 1.20%, e.g. 0.80% to 1.1%; a manganese content (% Mn) ranging from 0.10% to 1.0%, e.g. from 0.20% to 0.80%;
a silicon content (% Si) ranging from 0.10% to 1.50%, e.g. from 0.15% to 0.70%;
a sulphur content (% S) below 0.03%, e.g. below 0.01%;
a phosporus content (% P) below 0.03%, e.g. below 0.01%.

Alternatively, Following elements may be added to the composition:
chromium (% Cr): in amounts ranging from 0.10% to 1.0%, e.g. from 0.10 to 0.50%;
nickel (% Ni): in amounts ranging from 0.05% to 2.0%, e.g. from 0.10% to 0.60%;
cobalt (% Co): in amounts ranging from 0.05% to 3.0%; e.g. from 0.10% to 0.60%;
vanadium (% V): in amounts ranging from 0.05% to 1.0%, e.g. from 0.05% to 0.30%;
molybdenum (% Mo): in amounts ranging from 0.05% to 0.60%, e.g. from 0.10% to 0.30%;
copper (% Cu): in amounts ranging from 0.10% to 0.40%, e.g. from 0.15% to 0.30%;
boron (% B): in amounts ranging from 0.001% to 0.010%, e.g. from 0.002% to 0.006%;
niobium (% Nb): in amounts ranging from 0.001% to 0.50%, e.g. from 0.02% to 0.05%;
titanium (% Ti): in amounts ranging from 0.001% to 0.50%, e.g. from 0.001% to 0.010%;
antimony (% Sb): in amounts ranging from 0.0005% to 0.08%, e.g. from 0.0005% to 0.05%;
calcium (% Ca): in amounts ranging from 0.001% to 0.05%, e.g. from 0.0001% to 0.01%;
tungsten (% W): e.g. in an amount of about 0.20%;
zirconium (% Zr): e.g. in an amount ranging from 0.01% to 0.10%;
aluminium (% Al): preferably in amounts lower than 0.035%, e.g. lower than 0.015%, e.g. lower than 0.005%;
nitrogen (% N): in amounts less than 0.005%;
rare earth metals (% REM): in amounts ranging from 0.010% to 0.050%.

Metallic Coating

The steel filaments of the steel cord are preferably provided with a metallic coating in order to increase the corrosion resistance.

The metallic coating is preferably a zinc coating or a zinc alloy coating.

A zinc alloy coating may be a zinc aluminium coating that has an aluminium content ranging from 2 percent by weight to 12 percent by weight, e.g. ranging from 3% to 11%.

A preferable composition lies around the eutectoid position: Al about 5 percent. The zinc alloy coating may further have a wetting agent such as lanthanum or cerium in an amount less than 0.1 percent of the zinc alloy. The remainder of the coating is zinc and unavoidable impurities.

Another preferable composition contains about 10% aluminium. This increased amount of aluminium provides a better corrosion protection than the eutectoid composition with about 5% of aluminium.

Other elements such as silicon (Si) and magnesium (Mg) may be added to the zinc aluminium coating. With a view to optimizing the corrosion resistance, a particular good alloy comprises 2% to 10% aluminium and 0.2% to 3.0% magnesium, the remainder being zinc.

An example is 5% Al, 0.5% Mg and the rest being Zn.

A zinc or zinc alloy coating is preferably applied to the steel wire by means of a hot dip operation. The average thickness of the metal coating is preferably limited to 4 micrometer, e.g. to 3 micrometer.

With a view of inhibiting hydrogen gas evolution during the hardening of concrete reinforced with zinc coated metal elements, the steel cords may be treated with benzimidazole, e.g. by spraying or by dipping.

The metallic coating may also be a copper alloy such as brass. In comparison with zinc alloy coatings, brass coatings facilitate the diameter reduction by drawing. In an alkaline environment as concrete, brass may be sufficient to provide the required corrosion protection.

TABLE
Standard Deviation of Pull-out Tests

| | Standard deviation |
|---|---|
| Cord construction | on 6 samples |
| 5 × 0.35 with crimped filaments—invention | 6% |
| 3 + 5 × 7 × 0.12—reference | 51% |
| 3 × 3 × 0.15—reference | 32% |
| 19 + 9 × 7 × 1.2—reference | 47% |
| 3 × 3 × 0.2—reference | 21% |
| 3 + 2 × 0.225—reference | 26% |
| 7 + 4 × 0.12—reference | 66% |
| 3 × 0.3—reference | 94% |

### REFERENCE NUMBERS

100 construction made by 3D concrete printing
102 first layer
104 steel cord
106 second layer
108 steel cord
110 printer head or nozzle
112 concrete
114 direction of movement
200 steel cord
202 steel filament
204 steel filament
206 first crimp
208 second crimp
300 steel cord
302 steel filament
304 first crimp
306 second crimp
400 steel cord
402 steel strand
404 steel strand
406 steel filament
408 first crimp
500 steel filament
502 first pair of toothed wheels
504 second pair of toothed wheels
506 position of maximum of second crimp
508 position of minimum of second crimp
510 position of maximum of first crimp
512 position of minimum of first crimp

1. A concrete construction made by 3D concrete printing said construction comprising:
two or more layers of cementitious material extruded one above the other, and
at least one elongated steel element positioned inside said two or more layers along the length of said two or more layers and reinforcing said two or more layers,
said elongated steel element being:
either a single steel wire having a wire diameter D, D ranging from 0.20 mm to 2.0 mm, said single steel wire being provided with a first crimp, said crimp having a first amplitude ranging from 1.05×D to 5.00×D,
or a steel cord comprising steel filaments, said steel filaments having a maximum filament diameter d, d ranging from 0.03 mm to 0.65 mm, at least one of said filaments being provided with a first crimp, said first crimp having a first amplitude ranging from 1.05×d to 5.00×d.

2. The construction according to claim 1, said steel wire or at least of said filaments of said steel cord being provided with a second crimp different from said first crimp, said second crimp:
either having a second amplitude ranging from 1.05×D to 5.00×D in case of a single steel wire as reinforcement element,
or having a second amplitude ranging from 1.05×d to 5.00×d in case of a steel cord as reinforcement element.

3. The construction according to claim 2,
wherein said first amplitude differs from said second amplitude.

4. The construction according to claim 2,
wherein said first crimp has a first pitch,
wherein said second crimp has a second pitch,
said first pitch differing from said second pitch.

5. The construction according to claim 2,
wherein the first crimp lies in a first plane,
wherein the second crimp lies in a second plane,
the first plane being different from the second plane.

6. The construction according to claim 1,
said elongated steel element being a steel cord, all of the steel filaments of said steel cord being provided with a first crimp.

7. The construction according to claim 6,
said elongated steel element being a steel cord, all of the steel filaments of said steel cord being provided with a second crimp.

8. The construction according to claim 1, wherein said elongated steel element is provided with a zinc or zinc alloy coating and where said elongated steel elements has been treated with benzimidazole.

9. A concrete construction made by 3D concrete printing said construction comprising:
two or more layers of cementitious material extruded one above the other, and
at least one elongated steel element positioned inside said two or more layers along the length of said two or more layers and reinforcing said two or more layers,
said elongated steel element being a steel cord comprising steel strands, said steel strands comprising steel filaments, said steel strands having a maximum filament diameter d′, d′ ranging from 0.25 mm to 0.75 mm, at least one of said filaments being provided with a first crimp, said first crimp having a first amplitude ranging from 1.05×d′ to 5.00×d′.

10. A process of manufacturing a concrete construction according to claim 1, by way of 3D printing,
wherein said elongated steel element is fed simultaneously together with the cementitious material through a same printer head or nozzle.

11. A process of manufacturing a concrete construction according to claim 10, wherein said steel wire or at least of said filaments of said steel cord being provided with a second crimp different from said first crimp, said second crimp:
either having a second amplitude ranging from 1.05×D to 5.00×D in case of a single steel wire as reinforcement element,
or having a second amplitude ranging from 1.05×d to 5.00×d in case of a steel cord as reinforcement element.

12. A process of manufacturing a concrete construction according to claim 11,
wherein said first amplitude differs from said second amplitude.

13. A process of manufacturing a concrete construction according to claim 11,
wherein said first crimp has a first pitch,
wherein said second crimp has a second pitch,
said first pitch differing from said second pitch.

14. A process of manufacturing a concrete construction according to claim 11,
wherein the first crimp lies in a first plane,
wherein the second crimp lies in a second plane,
the first plane being different from the second plane.

15. A process of manufacturing a concrete construction according to claim 10, said elongated steel element being a steel cord, all of the steel filaments of said steel cord being provided with a first crimp.

16. A process of manufacturing a concrete construction according to claim 15, said elongated steel element being a steel cord, all of the steel filaments of said steel cord being provided with a second crimp.

17. A process of manufacturing a concrete construction according to claim 10, wherein said elongated steel element is provided with a zinc or zinc alloy coating and where said elongated steel elements has been treated with benzimidazole.

18. A process of manufacturing a concrete construction according to claim 9 by way of 3D printing,
wherein said elongated steel element is fed simultaneously together with the cementitious material through a same printer head or nozzle.
